(19) United States
(12) Patent Application Publication
(10) Pub. No.: US 2014/0253723 A1
(43) Pub. Date: Sep. 11, 2014

(54) MEASUREMENT APPARATUS AND METHOD OF MANUFACTURING ARTICLE

(71) Applicant: CANON KABUSHIKI KAISHA, Tokyo (JP)

(72) Inventor: Tsuyoshi YAMAZAKI, Utsunomiya-shi (JP)

(73) Assignee: CANON KABUSHIKI KAISHA, Tokyo (JP)

(21) Appl. No.: 14/196,900

(22) Filed: Mar. 4, 2014

(30) Foreign Application Priority Data
Mar. 6, 2013 (JP) 2013-044715

(51) Int. Cl. G01B 11/24

(52) U.S. Cl. CPC G01B 11/24
USPC 348/135

(57) ABSTRACT

The present invention provides a measurement apparatus which measures a shape of an inner surface of a measurement target object, including an irradiation unit configured to irradiate, with light emitted by a light source, different positions of the inner surface for respective wavelengths, an image capturing unit configured to capture the light reflected by the inner surface for the respective wavelengths, thereby generating captured data, and a calculation unit configured to calculate the shape of the inner surface based on the captured data corresponding to the respective wavelengths captured by the image capturing unit.

### BACKGROUND OF THE INVENTION

1. Field of the Invention

The present invention relates to a measurement apparatus which measures the shape of the inner surface of a measurement target object, and a method of manufacturing an article.

2. Description of the Related Art

For an industrial product such as a pipe or gear, the shape of its inner surface needs to be measured. Even for a living body organ of the human body such as the oral cavity or stomach, the shape of its inner surface needs to be measured. To achieve this, Japanese Patent Laid-Open No. 2007-285891 has proposed a technique regarding measurement of the shape of the inner surface of a measurement target object.

In the technique disclosed in Japanese Patent Laid-Open No. 2007-285891, light emitted by a semiconductor laser is formed into a ring shape via a conical mirror to irradiate the inner surface of a measurement target object. One sectional shape is obtained from the light reflected by the inner surface by using triangulation.

On the production site of industrial products, especially on the manufacturing line, there is a demand for a technique capable of measuring the shape of the inner surface of a measurement target object quickly (that is, in a short time). It is also required to quickly measure a structural deformation caused by heat or collision. Even for a living body organ of the human body that is difficult to fix, the shape of its inner surface needs to be measured quickly.

The technique disclosed in Japanese Patent Laid-Open No. 2007-285891 can measure one sectional shape of the inner surface of a measurement target object quickly (at once) in the radial direction of ring-shaped light. However, the entire inner surface (that is, in a direction perpendicular to the radial direction of ring-shaped light) cannot be measured at once. Also, the technique in Japanese Patent Laid-Open No. 2007-285891 requires a mechanism which moves, at high accuracy in a direction perpendicular to the radial direction of ring-shaped light, units including a semiconductor laser and a sensor for detecting light reflected by the inner surface. This increases the apparatus cost and size.

### SUMMARY OF THE INVENTION

The present invention provides a measurement apparatus advantageous for measuring the shape of the inner surface of a measurement target object.

According to one aspect of the present invention, there is provided a measurement apparatus which measures a shape of an inner surface of a measurement target object, including an irradiation unit configured to irradiate, with light emitted by a light source, different positions of the inner surface for respective wavelengths, an image capturing unit configured to capture the light reflected by the inner surface for the respective wavelengths, thereby generating captured data, and a calculation unit configured to calculate the shape of the inner surface based on the captured data corresponding to the respective wavelengths captured by the image capturing unit.

Further aspects of the present invention will become apparent from the following description of exemplary embodiments with reference to the attached drawings.

### BRIEF DESCRIPTION OF THE DRAWINGS

FIG. 1 is a schematic view showing the arrangement of a measurement apparatus as one aspect of the present invention.

FIG. 2 is a view for explaining calculation of the shape of the inner surface of a measurement target object by the calculation unit of the measurement apparatus shown in FIG. 1.

FIGS. 3A and 3B are views showing the detailed arrangement of the diffraction optical element of the measurement apparatus shown in FIG. 1.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

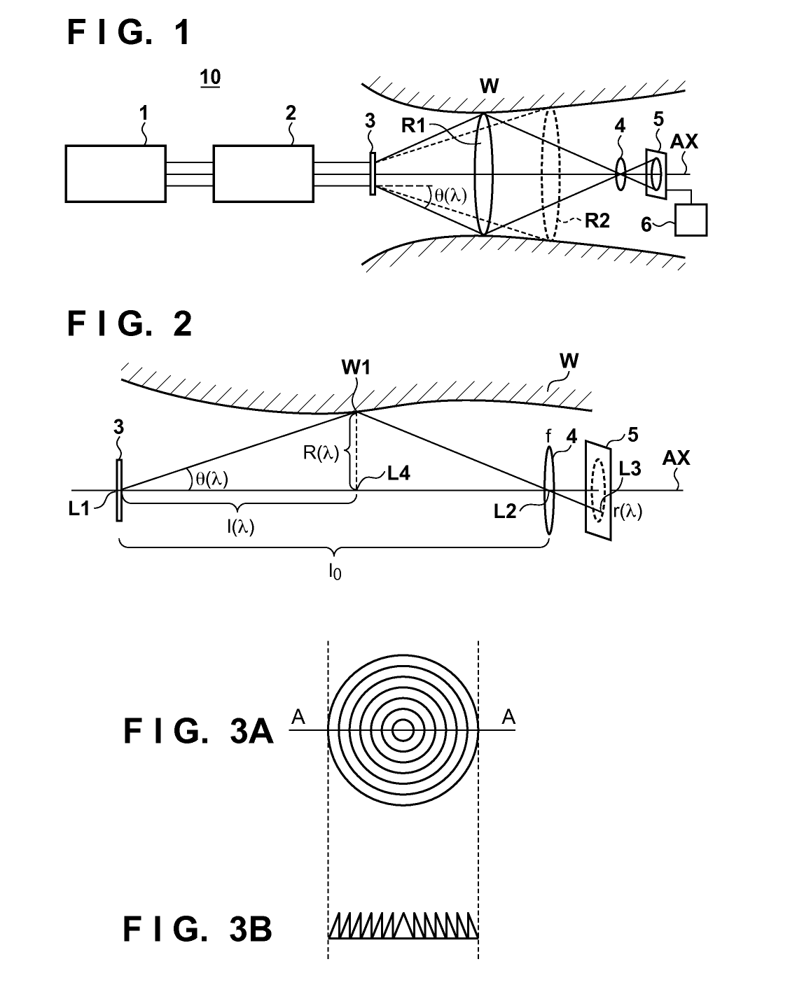

FIG. 1 is a schematic view showing the arrangement of a measurement apparatus 10 as one aspect of the present invention. The measurement apparatus 10 measures the shape of the inner surface of a measurement target object such as an industrial product (for example, pipe or gear) or a living body organ of the human body (for example, oral cavity or stomach). The measurement apparatus 10 includes a light source 1, selection unit 2, diffraction optical element 3, imaging optical system 4, image capturing unit 5, and calculation unit 6.

In the embodiment, the light source 1 is constructed by a multi-wavelength light source which emits light containing a plurality of wavelengths. For example, the light source 1 is constructed by a light source which emits broadband light, such as a SOA (Semiconductor Optical Amplifier), halogen lamp, or LED.

The selection unit 2 has a function of selectively emitting light of at least one wavelength among a plurality of wavelengths from light emitted by the light source 1. The selection unit 2 is constructed by, for example, a mechanism formed from a combination of a galvano-mirror and diffraction grating, or a variable-wavelength filter. Light traveling from the selection unit 2 (that is, light of a wavelength selected by the selection unit 2) enters the diffraction optical element 3. The selection unit 2 can change the wavelength of light to be emitted.

The diffraction optical element 3 is constructed by a computer generated hologram (CGH) or the like. The diffraction optical element 3 functions as an irradiation unit which irradiates, with light emitted by the light source 1, different positions of an inner surface W of a measurement target object for respective wavelengths. The diffraction optical element 3 forms light emitted by the light source 1 into ring-shaped light for the respective wavelengths, and irradiates different positions of the inner surface W of the measurement target object with the ring-shaped light. The diffraction optical element 3 is designed so that, when beams of different wavelengths enter the diffraction optical element 3, an angle (diffraction angle) θ defined by each beam and an optical axis AX changes depending on the wavelength. Beams of different wavelengths selected by the selection unit 2 enter the diffraction optical element 3 and irradiate, as ring-shaped light, different positions of the inner surface W of the measurement target object. The ring-shaped light formed from a beam of an arbitrary wavelength entering the diffraction optical element 3 forms an annular light section R1 (or R2).

The imaging optical system 4 is interposed between the diffraction optical element 3 and the image capturing unit 5. The imaging optical system 4 forms, into an image on the image capturing unit 5, light (ring-shaped light formed by the diffraction optical element 3) reflected by the inner surface W of the measurement target object.

The image capturing unit 5 is constructed by a CCD sensor, CMOS sensor, or the like. The image capturing unit 5 captures light reflected by the inner surface W of the measurement target object (light formed into an image by the imaging optical system 4) for each wavelength, thereby generating captured data.

The calculation unit 6 includes a CPU and memory. The calculation unit 6 calculates the shape (inner surface coordinates) of the inner surface W of the measurement target object based on captured data (captured images) corresponding to respective wavelengths captured by the image capturing unit 5.

Calculation of the shape of the inner surface W of the measurement target object by the calculation unit 6, that is, calculation of the shape of the inner surface W of the measurement target object based on a captured image corresponding to the light section R1 or R2 captured by the image capturing unit 5 will be described with reference to FIG. 2. The calculation will be explained in regard to a wavelength λ corresponding to the light section R1.

Referring to FIG. 2, ring-shaped light of a radius R(λ) which irradiates the inner surface W of the measurement target object forms an image on the image capturing unit 5 via the imaging optical system 4 having a focal length f. A magnification M(λ) of the imaging optical system 4 is given by:

$$magnification \text{:} M ( λ ) = \frac{- f}{{l}_{0} - l ( λ ) - f} \qquad ( 1 )$$

where l₀ is the distance from a position L1 of the diffraction optical element 3 to a position L2 of the imaging optical system 4 along the optical axis AX, and l(λ) is the distance from the position L1 of the diffraction optical element 3 to an irradiation position W1 irradiated with the ring-shaped light of the wavelength λ along the optical axis AX, that is, the distance from the position L1 of the diffraction optical element 3 to a position L4 on the optical axis AX that corresponds to the irradiation position W1.

A distance R(λ) from the optical axis AX to the irradiation position W1 of the ring-shaped light, and a distance l(λ) from the position L1 to the position L4 are given using the magnification M(λ):

$$\{ \begin{matrix}R ( λ ) = \frac{r ( λ )}{M ( λ )} = \frac{l ( λ ) + f - {l}_{0}}{f} r ( λ ) \\ l ( λ ) = \frac{R ( λ )}{tan θ ( λ )}\end{matrix} \qquad ( 2 )$$

where r(λ) is the distance of a light trace from the irradiation position W1 of the ring-shaped light of the wavelength λ (ring-shaped light irradiating the irradiation position W1) to a position L3 of the image capturing unit 5 on the optical axis AX, and θ(λ) is the angle (diffraction angle of the diffraction optical element 3 (elevation angle of light emerging from the diffraction optical element 3)) defined by the optical axis AX and a line segment connecting the irradiation position W1 of the ring-shaped light irradiating the inner surface W of the measurement target object and the position L1 of the diffraction optical element 3. Equations (2) are rewritten into:

$$\{ \begin{matrix}R ( λ ) = \frac{r ( λ ) tan θ ( λ ) ( f - {l}_{0} )}{f tan θ ( λ ) - r ( λ )} \\ l ( λ ) = \frac{R ( λ )}{tan θ ( λ )}\end{matrix} \qquad ( 3 )$$

Assume that the diffraction angle θ(λ) of the diffraction optical element 3, the focal length f of the imaging optical system 4, and the distance l₀ from the position L1 of the diffraction optical element 3 to the position L2 of the imaging optical system 4 along the optical axis AX are known as design values.

By using the distance r(λ) obtained by analyzing a captured image corresponding to the light section R1, and the relations given by equations (3), the distance R(λ) from the optical axis AX to the irradiation position W1 of the ring-shaped light, and the distance l(λ) from the position L1 to the position L4 can be calculated.

When the selection unit 2 sweeps or changes the wavelength λ of light emitted by the light source 1, the diffraction angle θ(λ) of the diffraction optical element 3 changes (different positions of the inner surface W of the measurement target object can be irradiated). Accordingly, the measurement apparatus 10 can obtain the shape of the inner surface W (shape of the entire inner surface) of the measurement target object based on the distance r(λ) obtained by analyzing a captured image corresponding to light of each wavelength λ, and the relations given by equations (3), without requiring a high-accuracy driving mechanism or rotation mechanism.

Next, the detailed arrangement of the diffraction optical element 3 will be explained with reference to FIGS. 3A and 3B. FIG. 3A is a plan view of the diffraction optical element 3. FIG. 3B is a sectional view of the diffraction optical element 3 shown in FIG. 3A taken along a line A-A. However, the diffraction optical element 3 is not limited to the following arrangement, and various modifications and changes can be made without departing from the scope of the invention.

As shown in FIGS. 3A and 3B, the diffraction optical element 3 is constructed by arraying diffraction gratings around the axis to be rotationally symmetrical (that is, arraying them concentrically). In general, a diffraction grating forms, from incident light, 1st-order diffraction light on only the same plane. However, by using the diffraction optical element 3 as shown in FIGS. 3A and 3B, ring-shaped light can be formed by rotating the 1st-order diffraction light about the rotation axis. As described above, the diffraction angle of the diffraction optical element 3 changes depending on the wavelength. Generally, the diffraction angle θ(λ) when parallel light enters the diffraction optical element 3 is given by:

sin θ(λ)=Nmλ (4)

where N is the number of grooves per unit length, m is the diffraction order, and λ is the wavelength. The diffraction angle θ(λ) becomes larger for a longer wavelength and smaller for a shorter wavelength.

In this way, light having passed through the diffraction optical element 3 forms ring-shaped light. By changing the wavelength λ of light entering the diffraction optical element 3, the diffraction angle θ(λ) can be changed. Thus, the ring-shaped light can be moved (scanned) along the optical axis AX.

Next, the detailed arrangement of the imaging optical system 4 will be explained. In FIG. 1, the imaging optical system 4 has been described as an optical system (imaging lens) having no wavelength dependence. As described above, however, the diffraction angle θ(λ) of the diffraction optical element 3 changes by changing the wavelength of light entering the diffraction optical element 3. A case will be examined, in which the measurement target object is a cylinder, and the diffraction optical element 3 is set so that the diffraction angle θ(λ) becomes larger as the wavelength of light entering the diffraction optical element 3 becomes shorter, and smaller as it becomes longer. In this case, the distance from the imaging optical system 4 to the object plane changes depending on the wavelength. If the imaging optical system 4 having no wavelength dependence is used, the imaging relationship is established for only one specific wavelength, and the imaging performance on the image capturing unit 5 may degrade for other wavelengths.

In such a case, the imaging optical system 4 includes a diffraction optical element in which, letting f₀ be the focal length for a wavelength λ₀, the focal length f(λ) for another wavelength λ is given by:

$$f ( λ ) = ( \frac{{λ}_{0}}{λ} ) {f}_{0} \qquad ( 5 )$$

Equation (5) represents that the focal length f(λ) is inversely proportional to the wavelength λ, and the focal length f(λ) becomes longer for a shorter wavelength and shorter for a longer wavelength. Therefore, the distance between the object plane and the imaging optical system 4 becomes longer for a shorter wavelength and shorter for a longer wavelength. This can suppress degradation of the imaging performance on the image capturing unit 5 when forming the object plane into an image on the image capturing unit 5. Note that the distance R(λ) from the optical axis AX to the irradiation position of ring-shaped light at the wavelength λ, and the distance l(λ) from the position L1 to the position L4 can be calculated using the focal length f(λ) of the imaging optical system 4.

In the measurement apparatus 10, the selection unit 2 sweeps or changes the wavelength of light emitted by the light source 1 to change the diffraction angle θ(λ) of the diffraction optical element 3. The shape of the inner surface W of the measurement target object can be obtained based on the distance r(λ) obtained from a captured image corresponding to each wavelength λ, and the relations given by equations (3). For example, when an SOA, diffraction grating, and MEMS mirror are used, the sweep rate at a wavelength of 50 nm or more becomes equal to or higher than 100 kHz. The image capturing unit 5 can capture an image at several ten Kfps or more. Thus, the measurement apparatus 10 can measure the shape of the inner surface W (shape of the entire inner surface) of the measurement target object more quickly than by the conventional technique though it depends on the number of images to be captured by the image capturing unit 5.

In the embodiment, the light source 1 is constructed by a multi-wavelength light source, but it may be constructed by a variable-wavelength light source capable of changing the wavelength of light having a single wavelength to be emitted. In this case, since the light source 1 can sweep or change the wavelength, the selection unit 2 which selects light of at least one wavelength from light emitted by the light source 1 can be omitted.

In the embodiment, before irradiating the inner surface W of the measurement target object with light emitted by the light source 1, the selection unit 2 selects the wavelength of light for irradiating the inner surface W of the measurement target object (that is, the wavelength is selected on the light source side with respect to the measurement target object). However, the inner surface W of the measurement target object may be irradiated with beams of a plurality of wavelengths, and the selection unit may select, from the beams of the respective wavelengths reflected by the inner surface W, the wavelength of a beam to be formed into an image on the image capturing unit 5 (that is, the selection unit may be arranged on the side of the image capturing unit with respect to the measurement target object and select a wavelength). At this time, the selection unit can change the wavelength of light to enter the image capturing unit.

<Embodiment of Method of Manufacturing Article>

A method of manufacturing an article in the embodiment is used to, for example, process an article of an industrial product such as a pipe or gear. The method of manufacturing an article according to the embodiment includes a step of measuring the shape of the inner surface of an article by using a measurement apparatus 10, and a step of processing the inner surface based on the measurement result in the measuring step. For example, the shape of the inner surface is measured using the measurement apparatus 10, and the inner surface is processed based on the measurement result so that the shape of the inner surface becomes a desired shape based on a design value or the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent application No. 2013-044715 filed on Mar. 6, 2013, which is hereby incorporated by reference herein in its entirety.

What is claimed is:

1. A measurement apparatus which measures a shape of an inner surface of a measurement target object, comprising:
an irradiation unit configured to irradiate, with light emitted by a light source, different positions of the inner surface for respective wavelengths;
an image capturing unit configured to capture the light reflected by the inner surface for the respective wavelengths, thereby generating captured data; and
a calculation unit configured to calculate the shape of the inner surface based on the captured data corresponding to the respective wavelengths captured by the image capturing unit.

2. The apparatus according to claim 1, wherein the irradiation unit forms the light emitted by the light source into ring-shaped light for the respective wavelengths, and irradiates the different positions of the inner surface with the ring-shaped light.

3. The apparatus according to claim 2, wherein the irradiation unit includes a diffraction optical element configured to form the ring-shaped light in correspondence with the different positions of the inner surface.

4. The apparatus according to claim 1, wherein the light source includes a multi-wavelength light source which emits light containing the plurality of wavelengths.

5. The apparatus according to claim 4, further comprising a selection unit configured to emit light of one wavelength among the plurality of wavelengths from the light emitted by the light source, and be able to change the wavelength of the light to be emitted,
wherein the irradiation unit irradiates, with light of one wavelength from the selection unit, one position among the different positions of the inner surface.

6. The apparatus according to claim 1, wherein the light source includes a variable-wavelength light source configured to be able to change a wavelength of light having a single wavelength to be emitted.

7. The apparatus according to claim 1, further comprising an imaging optical system configured to be interposed between the irradiation unit and the image capturing unit and form the light reflected by the inner surface into an image on the image capturing unit.

8. The apparatus according to claim 7, wherein the imaging optical system includes a diffraction optical element having different focal lengths for the respective wavelengths.

9. The apparatus according to claim 4, wherein
the irradiation unit irradiates the different positions of the inner surface with beams of a plurality of wavelengths from the multi-wavelength light source, and
the measurement apparatus further comprises a selection unit configured to cause a beam of one wavelength among the beams of the plurality of wavelengths reflected by the inner surface, to enter the image capturing unit, and be able to change the wavelength of the beam to enter the image capturing unit.

10. A method of manufacturing an article, comprising the steps of:
measuring a shape of an inner surface of an article by using a measurement apparatus; and
processing the inner surface based on the measured shape,
wherein the measurement apparatus includes:
an irradiation unit configured to irradiate, with light emitted by a light source, different positions of the inner surface for respective wavelengths;
an image capturing unit configured to capture the light reflected by the inner surface for the respective wavelengths, thereby generating captured data; and
a calculation unit configured to calculate the shape of the inner surface based on the captured data corresponding to the respective wavelengths captured by the image capturing unit.
